(19) United States
(12) Patent Application Publication
(10) Pub. No.: US 2007/0259540 A1
(43) Pub. Date: Nov. 8, 2007

(54) Grounded metal substrate in a socket and method of making

(75) Inventor: Attalee S. Taylor, Palmyra, PA (US)

Correspondence Address: Robert J. Kapalka, Suite 140, 4550 Linden Hill Road, Wilmington, DE, 19808-2952, US

(73) Assignee: Tyco Electronics Corporation, Middletown, PA (US)

(21) Appl. No.: 11/731,428

(22) Filed: Mar. 30, 2007

Related U.S. Application Data
(63) Continuation-in-part of application No. 11/429,800, filed on May 8, 2006.

(51) Int. Cl. H01R 12/00

(52) U.S. Cl. 439/68

(57) ABSTRACT

An electrical interconnection device including a metal substrate for receiving and holding a plurality of electrical contacts wherein at least one contact is electrically coupled to the substrate.

### CROSS REFERENCE TO RELATED APPLICATIONS

This application is a continuation-in-part of U.S. patent application Ser. No. 11/429,800, filed May 8, 2006, which is incorporated herein by reference.

### BACKGROUND

The present invention relates to electrical interconnection devices having a metal substrate for holding contacts, and to methods for making such interconnection devices.

Electrical interconnection devices are used to electronically couple components, such as a microprocessor, to a printed circuit board. Typical interconnection devices use multiple metal contacts to transmit electronic signals between the components. Increasing the rate of transmission and decreasing the overall size of the interconnection devices have been ongoing goals of the industry.

To improve the rate of transmission of these electronic signals, efforts have been made to increase the density of the connections within the interconnection device. In some interconnection devices, injection molded plastic housings are used to receive and support a plurality of electrical contacts. However, the True Position (TP), geometry and co-planarity across the plastic housings are limited by the response and variability of the polymer to the injection molding process. In addition, such plastic housings may be susceptible to shrinkage, warping, bowing and bending. Also, it is beneficial to shield the signal contacts from one another and prevent cross-talk therebetween. However, while these plastic housing structures may isolate the metal contacts from one another, they do not provide shielding. To shield the signal contacts and provide a larger ground path than is typically available in such non-conductive connectors, the plastic housing structures may be metallized or may be equipped with ground planes. Nevertheless, it may be difficult to manufacture plastic housings that meet the demands for increasingly small connectors. The thin walls separating the contacts may be weak and susceptible to breakage.

As disclosed in disclosed in U.S. Pat. No. 6,945,788 to Trout et al., rigid metal substrate structures have been proposed as an alternative to the plastic housings for supporting the signal contacts. These metal substrate structures may be sized to fit within a plastic housing and include a plurality of apertures sized to receive the signal contacts. The metal substrate structure provides a rigid substrate that is resistant to shrinkage. To insulate the signal contacts from one another and to secure the signal contacts within the apertures, each signal contact may be overmolded with an insulative plastic, which is swaged to the substrate.

Ungrounded metal or metallized substrates may encounter a “floating ground” or inductive charge from the electrical contacts therein. Accordingly, providing a fixed ground connection for the substrate can lessen or eliminate such a floating ground and inductive charges.

### SUMMARY

The present disclosure provides connector apparatuses for interconnecting components and methods for making such connectors. In one form, the present disclosure provides an electrical interconnection device for receiving and holding a plurality of electrical contacts. The electrical interconnection device includes a metal support substrate having an array of contact receiving apertures extending therethrough. Each of the contact receiving apertures is defined by an aperture wall and the contact receiving apertures are adapted to receive the plurality of electrical contacts. The array of contact receiving apertures includes a first and second subset of apertures. The first subset of apertures includes a dielectric layer coating the aperture wall for insulating the first subset of electrical contacts from said substrate. The second subset of apertures for receiving a second subset of electrical contacts are provided such that the second subset of electrical contacts are in electrical contact with the substrate.

In another embodiment of the disclosure, an electrical interconnection device is provided. The interconnection device includes a support substrate formed of metal and having a top surface and an opposing bottom surface. The support substrate includes first and second contact receiving apertures extending therethrough from said top surface to said bottom surface. Each of said first and second contact receiving apertures are defined by an aperture wall. A dielectric layer coats said first aperture wall. First and second electrical contacts are respectively disposed in said first and second contact receiving apertures. The dielectric layer insulates said first electrical contact from said metal, and said second electrical contact is electrically coupled to said metal.

In another form, the present disclosure provides a method for manufacturing an electrical interconnection device. The method comprises the steps of constructing a metal support substrate having a top surface and an opposing bottom surface; forming a plurality of electrical contact receiving apertures extending through the metal support substrate from the top surface to the bottom surface, each of the plurality of electrical contact receiving apertures being defined by an aperture wall; covering at least one aperture; and coating the aperture wall of each uncovered aperture of the plurality of electrical contact receiving apertures with a dielectric composition.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a top view of a socket connector apparatus according to one embodiment of the present invention;

FIG. 2 is a side view of a socket connector apparatus of FIG. 1;

FIG. 3 is a partial, top sectional view of the socket connector apparatus of FIG. 2 taken along lines 3-3;

FIG. 4 is a partial, side sectional view of the socket connector apparatus of FIG. 1 taken along lines 4-4;

FIG. 5 is another partial, side sectional view of the socket connector apparatus of FIG. 1 taken along lines 5-5;

FIG. 6 is a partial, side sectional view of a socket connector apparatus according to another embodiment of the present invention;

FIG. 7 is a top view of a socket connector apparatus according to another embodiment of the present invention;

FIG. 8 is a side view of a socket connector apparatus of FIG. 7;

FIG. 9 is a partial, top sectional view of the socket connector apparatus of FIG. 8 taken along lines 9-9; and

FIG. 10 is a partial, side sectional view of the socket connector apparatus of FIG. 7 taken along lines 10-10.

Corresponding reference characters indicate corresponding parts throughout the several views. Although the drawings represent embodiments of the present disclosure, the drawings are not necessarily to scale and certain features may be exaggerated in order to better illustrate and explain the present disclosure. Although the exemplification set out herein illustrates embodiments of the invention, in several forms, the embodiments disclosed below are not intended to be exhaustive or to be construed as limiting the scope of the disclosure to the precise forms disclosed.

### DETAILED DESCRIPTION

The embodiments hereinafter disclosed are not intended to be exhaustive or limit the disclosure to the precise forms disclosed in the following description. Rather the embodiments are chosen and described so that others skilled in the art may utilize its teachings.

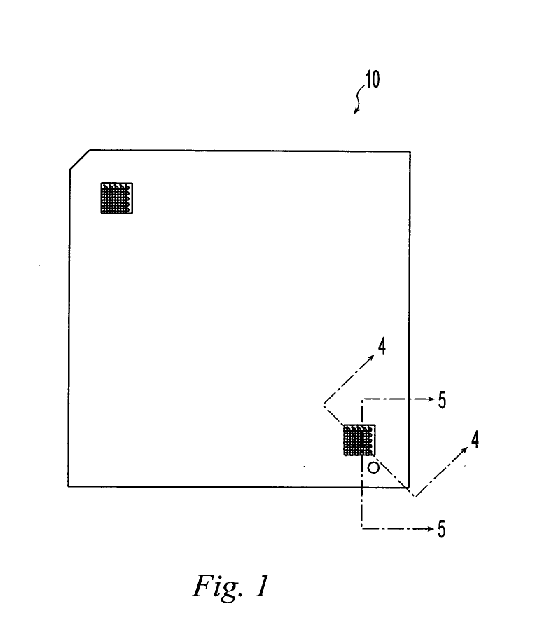

Referring to FIGS. 1-5, electrical interconnection device in the form of socket connector apparatus 10 according to one embodiment of the present invention will now be described. As illustrated in FIGS. 1-2 and 4-5 and described in further detail below, electrical interconnection device is in the form of ball grid array (BGA) socket connector apparatus 10 which may be used to interface or electronically couple a device, such as a microprocessor, with a circuit board. However, although the present invention is exemplified in the context of a BGA socket connector, the present invention is not limited to BGA socket connectors. Rather, the present invention may be adapted for use as any electrical interconnect structure, including, for example, a Land Grid Array (LGA) socket, Column Grid Array (CGA), right angle connectors and backplane connectors.

As illustrated in FIGS. 1-2 and 4-5, socket connector apparatus 10 generally includes support substrate 12 and electrical contacts 18 supported in support substrate 12. Support substrate 12 includes top surface 22, opposing bottom surface 24 and an array of contact receiving apertures 14 extending through substrate 12 from top surface 22 to bottom surface 24. Each of contact receiving apertures 14 is defined by aperture wall 20 and is sized to receive one of electrical contacts 18. Array of contact receiving apertures 14 may be arranged in any pattern and may include any number of apertures 14. Although the illustrative embodiment of FIGS. 1-5 show an array of contact receiving apertures, support substrate 12 may include a single contact receiving aperture.

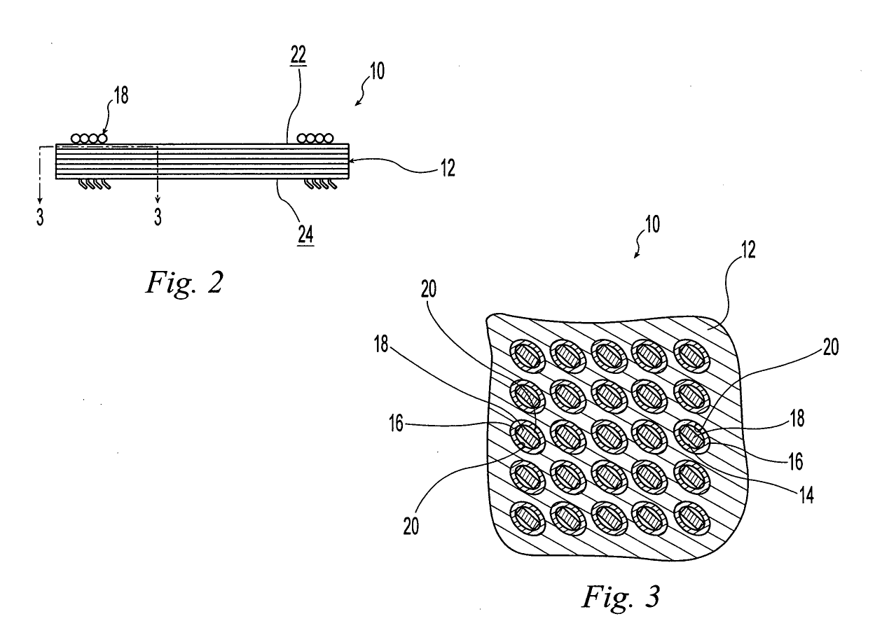

Turning now to FIGS. 2 and 4-5, support substrate 12 is formed of a plurality of metal layers or sheets 26a-26g stacked atop and bonded to one another by any suitable method including, for example, that disclosed in U.S. Patent Application Publication No. 2005/0221634, filed as U.S. patent application Ser. No. 10/818,038 on Apr. 5, 2004 in the names of Hilty et al., entitled Bonded Three Dimensional Metal Laminate Structure and Method, assigned to the assignee of the present invention and hereby incorporated by reference. Each of metal layers 26a-26g is formed of a rigid base metal such as copper, iron, steel, aluminum, tin, nickel, cobalt, titanium, zinc or alloys thereof. Each of metal layers 26a-26g may be formed of the same or different base metals. In some cases it may be beneficial for top layer 26a to be formed of a first metal, while bottom layer 26g is formed of a second different metal. For instance, when apparatus 10 is incorporated in a CGA device for connecting a chip to a circuit board, top layer 26a may be made of a metal, such as copper, to match the Coefficient of Thermal Expansion (CTE) of a circuit board, while the bottom layer 26g may be made of an alloy to match the CTE of a ceramic of the chip. Furthermore, in this particular embodiment, apparatus 10 may be composed of two parts that fit together; the first piece including top layer 26a and the second piece including bottom layer 26g.

Referring still to FIGS. 2 and 4-5, each of layers 26a-26g has a thickness t, which may vary depending on the application. For instance, in one exemplary embodiment, thickness t of each of layers 26a-26g is between about 0.1 mm and 0.3 mm and, therefore, metal substrate 12 has an overall thickness T of between about 0.7 mm and 2.1 mm. Each of layers 26a-26g includes an array of apertures, which cooperate with one another when layers 26a-26g are properly aligned and stacked atop one another to form contact receiving apertures 14. Each of layers 26a-26g may include alignment features such as indents, slots, points, pips, barbs or apertures (not shown) to facilitate the proper alignment and stacking of layers 26a-26g. Layers 26a-26g may be formed by known means including, for example, chemical etching or die stamping.

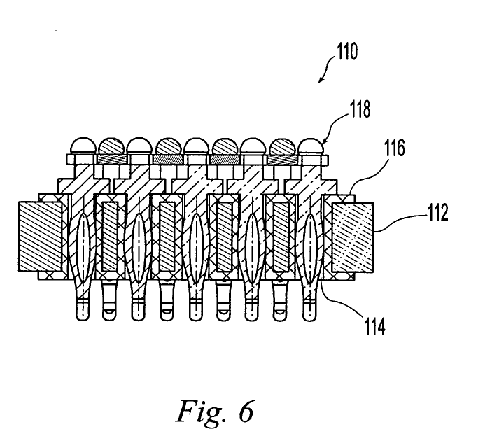

It should be understood that, although support substrate 12 is illustrated as having seven metal layers 26a-26g, the support substrate of the present invention may have any number of layers. Further, each of layers 26a-26g need not be of equal thickness, but may vary in thickness. In addition, the overall thickness of substrate 12 may vary. It should also be understood that support substrate 12 may be formed of a single metal layer, rather than a laminate of multiple metal layers, as shown in FIG. 6 and discussed in further detail below. In addition, each metal layer need not be of the same geometry. Rather, the layers could include various geometrical variations such as steps, shoulders, pockets or holes. In addition, support substrate, particularly top and bottom surfaces 22, 24 and/or aperture wall 20 of apertures 14, may include barbs, ridges, bumps or other surface texture features to assist in the binding of dielectric layer 16 to support substrate 12.

Referring still to FIGS. 3-5, socket connector apparatus 10 also includes dielectric layer 16, which coats and insulates aperture wall 20. Dielectric layer 16 may also extend outwardly from aperture 14 to coat all or a portion of top and bottom surfaces 22, 24 of support substrate 12. Dielectric layer 16 is formed of a dielectric material capable of insulating metal support substrate 12 from contact 18 disposed in aperture 14. As discussed in further detail below, the dielectric material should also be durable enough to resist penetration by contact 18 when contact 18 is loaded into aperture 14. Suitable dielectric materials may include ceramics, glass and plastics, including both thermoset polymers and thermopolymers. Suitable dielectric materials may be in any form including powder, liquid and/or gas and, if necessary, may be cured using any suitable means, such as heat, radiation and catalysts. For example, thermoplastic resin powder coatings suitable for use as a dielectric material may include polyamide, polyester, polyether-ether-ketone (PEEK), polypropylene, polyethylene and fluoropolymers. In one particular embodiment, the dielectric material is Scotchcast™ Electrical Resin 5230N, an epoxy resin available from 3M of St. Paul, Minn. Additional examples of suitable commercially available thermoplastic powder coating materials include Rohm & Haas polyamides and polyesters, Victrex PEEK, and Hyflon fluoropolymers from Solvay Solexis. Examples of suitable commercially available thermosetting powder coatings include Stator Red epoxy from DuPont, Resicoat epoxy from Akzo Nobel, Mor-Temp silicone from Morton International, and Torlon polyamide-imide from Solvay.

The dielectric material may be applied to support substrate 12 using any suitable coating techniques including, for example, electrostatic fluidized bed methods, liquid dip coating methods, electrodeposition methods, vapor deposition methods, overmolding and spray coating. In one particular embodiment, the Scotchcast™ Electrical Resin 5230N is applied using an electrostatic fluidized bed method. Dielectric layer 16 has a thickness t_{d}, which may vary depending on the size and structure of contact 18 and aperture 14. In one particular embodiment, dielectric layer 16 has a thickness t_{d} of between about 0.075 mm to 0.125 mm (0.003 inches-0.005 inches).

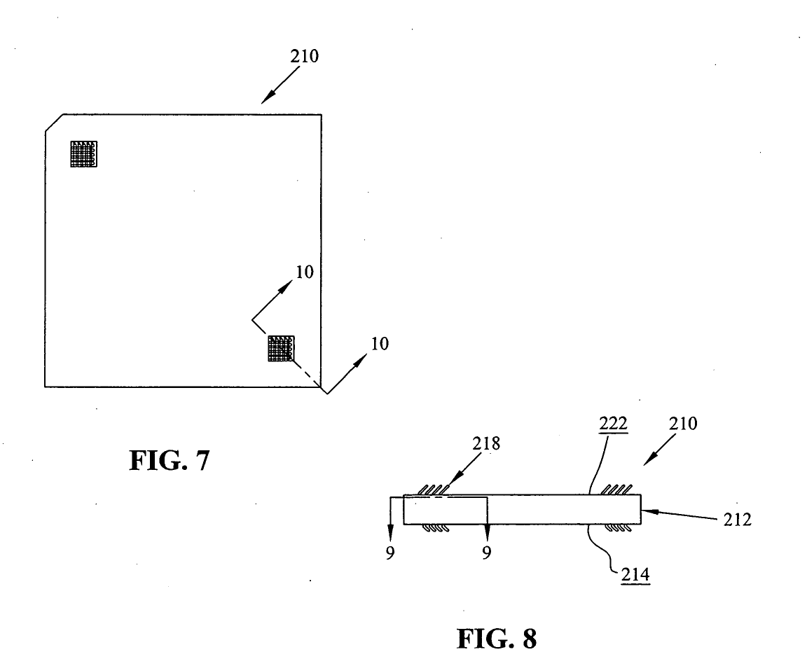

As suggested above, the dielectric material may be applied to aperture wall 20 of each of apertures 14 such that dielectric layer 16 coats aperture wall 20. The dielectric material may also be applied to a portion of top and/or bottom surfaces 22, 24 of support substrate 12 proximal apertures 14 to provide further insulation between contact 18 and metal support substrate 12. The efficiency of the manufacture of connector apparatus 10 may be further improved by avoiding the selective application of the dielectric material to aperture wall 20 and a portion of top and bottom surfaces 22, 24 and, instead, applying the dielectric material to all exposed surfaces of support substrate 12 including aperture wall 20 and top and bottom surfaces 22, 24. It should be understood that aperture wall 20 of every one of the plurality of apertures 14 need not be coated. For instance, as discussed below with respect to FIGS. 7-10, it may be desirable to only coat a selected one or few of apertures 14, in which case, those apertures 14 not requiring dielectric layer 16 may be plugged during the application of the dielectric material.

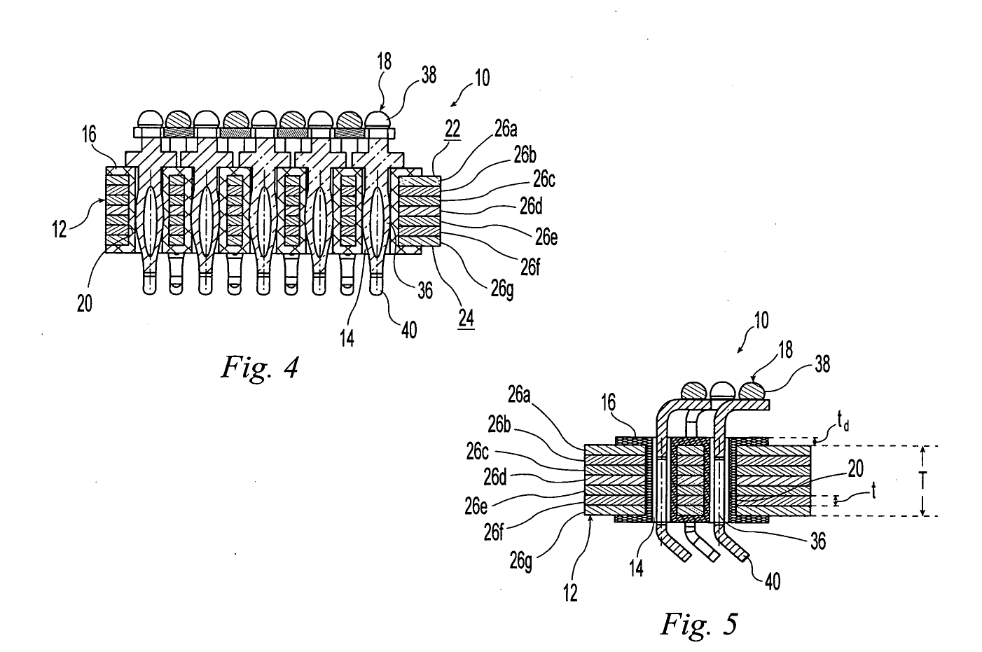

Referring now to FIGS. 4-5, each of contacts 18 are formed of a conductive metal such as copper, iron, steel, aluminum, tin, nickel, cobalt, titanium, zinc or alloys thereof. Each of contacts 18 includes resilient body portion 36, which is configured to fit within coated aperture 14 and is adapted to bias outwardly against aperture wall 20 to thereby hold body 36 within aperture 14 by interference fit. More specifically, body 36 is in the form of an eye-of-the-needle contact. Each of contacts 18 also include upper ball contact 38 extending from one end of body 36 and protruding from aperture 14 proximal top surface 22 of support substrate 12. Lower pin contact 40 extends from the end of body 36 opposite upper contact 38 and protrudes from aperture 14 proximal bottom surface 24 of support substrate 12. Although contacts 18 of the exemplary embodiment are illustrated in FIGS. 1-6 and described above as eye-of-the-needle ball contacts, the present invention may employ any known contact design.

Contacts 18 are directly loaded into coated apertures 14 by inserting lower pin contact 40 through, and forcing body 36, into aperture 14. As body 36 is positioned in aperture 14, body 36 biases and scrapes against dielectric layer 16, but does not penetrate dielectric layer 16. Once inserted into aperture 14, body 36 is held by interference fit against dielectric layer 16 in aperture 14.

Metal support substrate 12 provides connector apparatus 10 with a rigid and stable support structure that resists bending and bowing, while dielectric layer 16 insulates contact 18 from metal support substrate 12. Dielectric layer 16 also eliminates the need for overmolding or coating contacts 18 prior to loading in apertures 14, and allows contact 18 to be directly loaded into apertures 14.

Turning now to FIG. 6, connector apparatus 110 according to another embodiment of the present invention is illustrated. Connector apparatus 110 includes support substrate 112, which is formed of a single metal layer rather than multiple layers. Apertures 114 extend through substrate 112 and receive contacts 118. Apertures 114 are coated with dielectric layer 116 as described above with respect to connector apparatus 10. The single metal layer of support substrate 112 may be formed by known means including, for example, chemical etching or die stamping.

Referring to FIGS. 7, 8, electrical interconnection device in the form of socket connector apparatus 210 according to another embodiment of the present invention will now be described. Electrical interconnection device is in the form of land grid array (LGA) socket connector apparatus 210 which may be used to interface or electronically couple a device, such as a microprocessor, with a circuit board. However, although the present invention is exemplified in the context of an LGA socket connector, the present invention is not limited to LGA socket connectors. Rather, the present invention may be adapted for use as any electrical interconnect structure, including, for example, a Ball Grid Array (BGA) socket, Column Grid Array (CGA), right angle connectors and backplane connectors.

As illustrated in FIGS. 7-10, socket connector apparatus 210 generally includes support substrate 212 and electrical contacts 218 supported in support substrate 212. Support substrate 212 includes top surface 222, opposing bottom surface 224 and an array of contact receiving apertures 214 extending through substrate 212 from top surface 222 to bottom surface 224. Each of contact receiving apertures 214 is defined by aperture wall 220 and is sized to receive one of electrical contacts 218. Array of contact receiving apertures 214 may be arranged in any pattern and may include any number of apertures 214. Although the illustrative embodiment of FIGS. 7-10 shows an array of contact receiving apertures 214, support substrate 212 may include a single contact receiving aperture 214.

Turning now to FIGS. 8 and 10, support substrate 212 is formed from a single metal layer. Embodiments are also envisioned where substrate 212 is formed of a plurality of metal layers or sheets stacked atop and bonded to one another by any suitable method as discussed above. Additionally, while substrate 212 is described as metal, embodiments are also envisioned that utilize metal coated plastic, metal impregnated plastic, or any other conductive material.

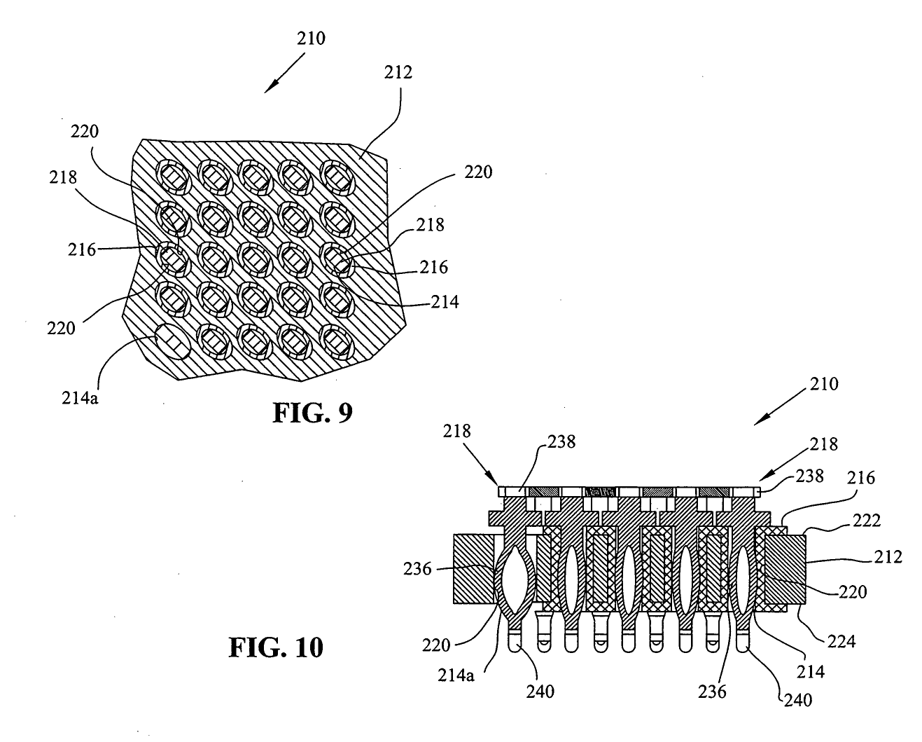

Referring still to FIGS. 9, 10, socket connector apparatus 210 also includes dielectric layer 216, which coats and insulates aperture wall 220. Dielectric layer 216 is similar to dielectric layer 16 and may also extend outwardly from aperture 214 to coat all or a portion of top and bottom surfaces 222, 224 of support substrate 212. As discussed in further detail below, the dielectric material should also be durable enough to resist penetration by contact 218 when contact 218 is loaded into aperture 214.

The dielectric material may be applied to support substrate 212 using any suitable coating technique including, for example, electrostatic fluidized bed methods, liquid dip coating methods, electrodeposition methods, vapor deposition methods, overmolding and spray coating. In one particular embodiment, the Scotchcast™ Electrical Resin 5230N is applied using an electrostatic fluidized bed method. Dielectric layer 216 has a thickness which may vary depending on the size and structure of contact 218 and aperture 214. In one particular embodiment, dielectric layer 216 has a thickness of between about 0.075 mm to 0.125 mm (0.003 inches-0.005 inches).

As suggested above, the dielectric material may be applied to aperture wall 220 of each of apertures 214 such that dielectric layer 216 coats aperture wall 220. The dielectric material may also be applied to a portion of top and/or bottom surfaces 222, 224 of support substrate 212 proximal apertures 214 to provide further insulation between contact 218 and metal support substrate 212. It should be understood that aperture wall 220 of every one of the plurality of apertures 214 need not be coated. As shown in FIG. 10, selected one aperture 214a, or more than one of apertures 214, is not coated with dielectric layer 216. Aperture 214a is plugged or masked during the application of the dielectric layer 216. Accordingly, metal substrate 212 is exposed within aperture 214a. This selective coating and exposure separates apertures 214, 214a into first and second subsets of apertures. Aperture(s) 214 of the first subset is/are coated with dielectric layer 216 and aperture(s) 214a of the second subset is/are exposed.

Referring now to FIG. 10, each of contacts 218 are formed of a conductive metal such as copper, iron, steel, aluminum, tin, nickel, cobalt, titanium, zinc or alloys thereof. Each of contacts 218 includes resilient body portion 236 which is configured to fit within coated aperture 214 and is adapted to bias outwardly against aperture wall 220 to thereby hold body 236 within aperture 214 by interference fit. More specifically, body 236 is in the form of an eye-of-the-needle contact. Each of contacts 218 also includes upper pin contact 238 extending from one end of body 236 and protruding from aperture 214, 214a proximal top surface 222 of support substrate 212. Lower pin contact 240 extends from the end of body 236 opposite upper pin contact 238 and protrudes from aperture 214, 214a proximal bottom surface 224 of support substrate 212. Although contacts 218 of the exemplary embodiment are illustrated in FIGS. 7-10 and described above as eye-of-the-needle contacts, the present invention may employ any known contact design.

Contacts 218 are directly loaded into apertures 214, 214a by inserting lower pin contact 240 through, and forcing body 236, into aperture 214, 214a. As body 236 is positioned in aperture 214, body 236 biases and scrapes against dielectric layer 216, but does not penetrate dielectric layer 216. Likewise, as body 236 is positioned in aperture 214a, body 236 biases and scrapes against wall 220. Once inserted into aperture 214, 214a, body 236 is held by interference fit against dielectric layer 216 in aperture 214, and against wall 220 in aperture 214a.

Metal support substrate 212 provides connector apparatus 210 with a rigid and stable support structure that resists bending and bowing, while dielectric layer 216 insulates contact 218 from metal support substrate 212. Dielectric layer 216 also eliminates the need for overmolding or coating contacts 218 prior to loading in apertures 214, and allows contact 218 to be directly loaded into apertures 214.

The interference fit of body 236 to wall 220 in aperture 214a electrically couples body 236 and substrate 212. Aperture 214a is chosen such that body 236 received therein corresponds to system ground contacts of the associated printed circuit board and chip. Accordingly, when assembled, substrate 212 is electrically grounded to system ground. Such grounding provides a matched impedance for adjacent contacts. Furthermore, dielectric layer 216 insulates other bodies 236 from grounded substrate 212.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An electrical interconnection device for receiving a plurality of electrical contacts, the electrical interconnection device comprising:
a support substrate having an array of contact receiving apertures extending therethrough, each of the contact receiving apertures being defined by an aperture wall, the array of contact receiving apertures adapted to receive the plurality of electrical contacts, the array of contact receiving apertures including:
a first subset of apertures for receiving a first subset of electrical contacts, including a dielectric layer coating the aperture wall of the first subset of apertures for insulating the first subset of electrical contacts from said substrate, and
a second subset of apertures for receiving a second subset of electrical contacts, such that the second subset of electrical contacts is in electrical contact with the substrate.

2. The electrical interconnection device of claim 1, wherein the second set of apertures are positioned to receive the second subset of electrical contacts that are electrically coupled to system ground.

3. The electrical interconnection device of claim 1, wherein said dielectric layer comprises a plastic.

4. The electrical interconnection device of claim 1, wherein said dielectric layer comprises a ceramic.

5. The electrical interconnection device of claim 1, wherein said dielectric layer is a cured dry powder coating.

6. The electrical interconnection device of claim 1, wherein said dielectric layer is a cured liquid dip coating.

7. The electrical interconnection device of claim 1, wherein the second subset of apertures includes only one aperture.

8. A electrical interconnection device comprising:
a support substrate formed of metal and having a top surface and an opposing bottom surface, said support substrate including first and second contact receiving apertures extending therethrough from said top surface to said bottom surface, each of said first and second contact receiving apertures being defined by an aperture wall;
a dielectric layer coating said first aperture wall; and
first and second electrical contacts respectively disposed in said first and second contact receiving apertures, said dielectric layer insulating said first electrical contact from said metal, and said second electrical contact being electrically coupled to said metal.

9. The electrical interconnection device of claim 8, said second electrical contact and said second contact receiving aperture are positioned to align with contacts of a printed circuit board and chip that are associated with system ground.

10. The electrical interconnection device of claim 8, wherein said dielectric layer comprises a plastic.

11. The electrical interconnection device of claim 8, wherein said dielectric layer comprises a ceramic.

12. The electrical interconnection device of claim 8, wherein said dielectric layer coats at least a portion of said top and bottom surfaces.

13. The electrical interconnection device of claim 8, wherein each of said plurality of electrical contacts includes a biasing body portion and a contact portion extending from said body portion, said biasing body portion of said first electrical contact is held by interference fit against said dielectric layer within said first contact receiving aperture, and said biasing body portion of said second electrical contact is held by interference fit against said metal within said second contact receiving aperture.

14. A method for manufacturing an electrical interconnection device comprising the steps of:
constructing a metal support substrate having a top surface and an opposing bottom surface;
forming a plurality of electrical contact receiving apertures extending through the metal support substrate from the top surface to the bottom surface, each of the plurality of electrical contact receiving apertures being defined by an aperture wall;
covering at least one aperture; and
coating the aperture wall of each uncovered aperture of the plurality of electrical contact receiving apertures with a dielectric composition.

15. The method of claim 14, wherein the at least one aperture is selected to correspond to the position of a system ground terminal.

16. The method of claim 14, wherein said step of coating the constructed support substrate includes applying the dielectric composition using an electrostatic fluidized bed.

17. The method of claim 16, wherein said step of coating the constructed support substrate includes applying the dielectric composition using an electrodeposition technique.

18. The method of claim 16, further comprising the step of loading a contact member in at least one of the array of contact receiving apertures after the step of coating the constructed support member.

19. The method of claim 16, wherein said step of coating the aperture wall also includes coating at least a portion of the top and bottom surfaces of the support substrate with the dielectric composition.

20. The method of claim 16, wherein said dielectric composition comprises an epoxy powder resin.
